(19) United States
(12) Patent Application Publication
(10) Pub. No.: US 2007/0075095 A1
(43) Pub. Date: Apr. 5, 2007

(54) Flexible container with mirrored outer surface

(76) Inventors: Joseph Sherman, Tarzana, CA (US); Sigal Sherman, Tarzana, CA (US)

Correspondence Address: Ira M. Siegel;LAW OFFICES OF IRA M. SIEGEL, Suite 970, 433 N. Camden Drive, Beverly Hills, CA, 90210, US

(21) Appl. No.: 11/245,280

(22) Filed: Oct. 5, 2005

(51) Int. Cl. B67D 1/07; B65D 37/00

(52) U.S. Cl. 222/192; 222/215

(57) ABSTRACT

The invention is a flexible-walled container for lotion, including sun protection lotion, moisturizer lotion and other lotions and similar liquids, which container includes a mirrored material as one of its components so that a user will have a mirror available whenever the user applies or reapplies the lotion. In a preferred embodiment, the container is a typical flexible, collapsible tube which has a circular end cap at one end and is sealed at its other end by a straight line seal. In this preferred embodiment, the invention is completed when a mirrored tab is adhesively affixed to the tube near the straight line seal.

1. Field of the Invention

This invention relates to lotion containers.

2. Prior Art

With the realization that unprotected exposure to the sun's rays can lead to skin cancer, people have been applying sun protective lotion to their faces and other exposed skin surfaces on a regular basis. Throughout the day, people reapply sun protective lotion often. As a result, people will often carry their sun protection lotion with them throughout the day.

It is important to cover all parts of the face with sun protective lotion. If any spot is uncovered, it can be severely burned in a short period of time due to the sensitive nature of facial skin. On the other hand, because sun protective lotion is often opaque and white unless it is thoroughly worked into the skin, unattractive lotion smears often appear on the user's face.

Because users of sun protective lotion often apply such lotion while the user's are outdoors (e.g., while at the beach, hiking, working, running errands) and are not carrying much more than their keys, money and sun protective lotion, they do not have ready access to mirrors while applying, or reapplying, the lotion. Since the user cannot see the results of his or her attempt to apply the lotion to his or her face, some spots on a user's face remain unprotected while others bear unattractive white smears.

Other materials are also used to protect the facial and body skin, regardless of exposure to the sun, such as skin moisturizers and similar lotions. People applying these lotions have been applying them on a regular basis, and will carry their skin moisturizer lotion with them. If any spot on the skin is uncovered, that spot is subject to damage caused when the skin is dry. On the other hand, because skin moisturizer lotions are often opaque, unless they are thoroughly worked into the skin, unattractive lotion smears often appear on the users faces.

Lotions and similar liquids are often carried in containers which are flexible, collapsible tubes or bottles having flexible walls so that the user can squeeze the lotion out of the container onto their hands. (A user's hand is the applicator of choice for lotions.)

While flexible-walled containers as described above have been around for years, and while the problems associated with misapplication of lotion have also been known for as long, no prior art flexible-walled container has helped solve the problems. The invention described herein solves these problems. The invention is a flexible-walled container wherein a wall is provided with a mirrored material. The user can squeeze the lotion on to one of his or her hands and, without having to put anything down or reach for anything else, can apply the lotion to his or her face with the guidance provided by the mirror held (along with the flexible-walled container of which it is a part) in the other hand.

In the prior art, rigid bottles with mirrors have been known. The Jim Beam decanters with a mirror can be seen, as of Sep. 16, 2005, at the following web pages:

http://cgi.ebay.com/ws/eBayISAPI.dll?ViewItem&item=
7183502640; and
http://cgi.ebay.com/ws/eBayISAPI.dll?ViewItem&item=
7182711761&rd=1.

Rigid bottles with mirrors for mascara, lip gloss and eye liner are also known. These can be seen, as of Sep. 16, 2005, at the following web page:

http://www.chochuang.com.tw/cgibin/productfn/
pdt_product_lst.pl@pdttype=r&cserialnum=15,19.htm.

But rigid-walled containers are not favored for hand-applied substances. Flexible-walled containers are favored, but, notwithstanding their long use, heretofore they have not been provided with mirrors.

### SUMMARY OF THE INVENTION

The invention is a flexible-walled container for lotion and similar liquids, including sun protection lotion, moisturizer lotion and other lotions, which container includes a mirrored material as one of its components so that a user will have a mirror available whenever the user applies or reapplies the lotion. In a preferred embodiment, the container is a typical flexible, collapsible tube which has a circular end cap at one end and is sealed at its other end by a straight line seal. In this preferred embodiment, the invention is completed when a mirrored tab is adhesively affixed to the tube near the straight line seal.

### BRIEF DESCRIPTION OF THE DRAWINGS

1. FIG. 1 is a front elevational view of an embodiment of the invention comprising a flexible, collapsible tube with a mirror affixed to it.

2. FIG. 2 is a side elevational view of the embodiment of the invention shown in FIG. 1.

3. FIG. 3 is a rear elevational view of the embodiment of the invention shown in FIG. 1.

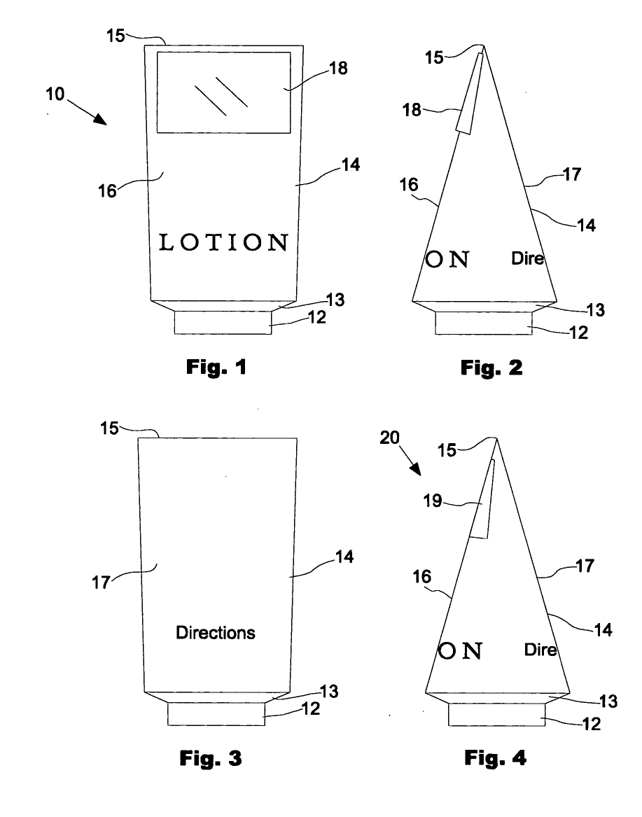

4. FIG. 4 is a side elevational view of a second embodiment of the invention comprising a flexible, collapsible tube with a mirror forming part of the wall of the tube.

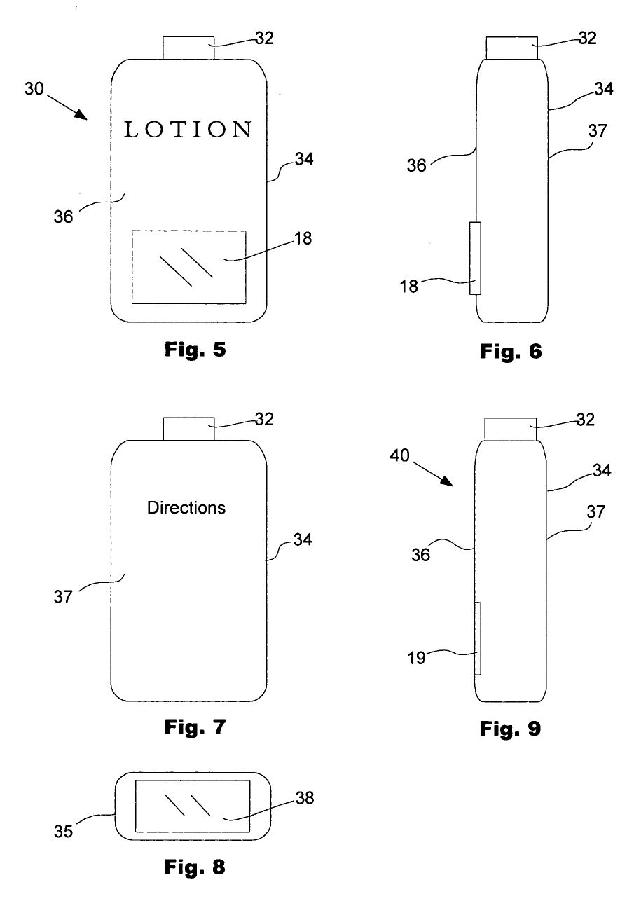

5. FIG. 5 is a front elevational view of a third embodiment of the invention comprising a flexible-walled bottle with a mirror affixed to it.

6. FIG. 6 is a side elevational view of the embodiment of the invention shown in FIG. 5.

7. FIG. 7 is a rear elevational view of the embodiment of the invention shown in FIG. 5.

8. FIG. 8 is a bottom plan view of the embodiment of the invention shown in FIG. 5, with a mirror affixed to the bottom wall of the bottle.

9. FIG. 9 is a side elevational view of a fourth embodiment of the invention comprising a bottle with a mirror forming part of the wall of the bottle.

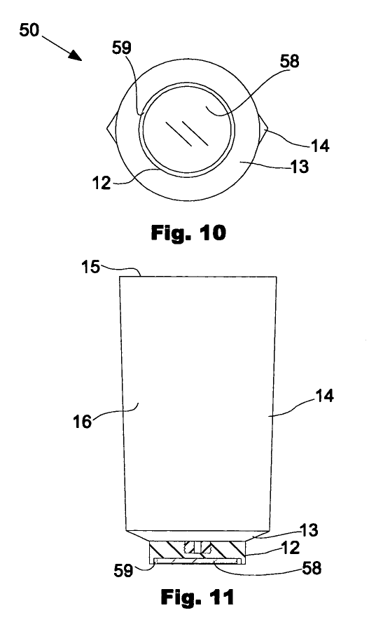

10. FIG. 10 is a bottom plan view of a fifth embodiment of the invention with a mirror affixed to a closing cap.

11. FIG. 11 is a cross-sectional side view of the embodiment of the invention shown in FIG. 10.

### DETAILED DESCRIPTION OF THE INVENTION

The preferred embodiment of the subject invention is illustrated in the attached drawings which are referred to herein. The same reference numeral will be used to identify identical elements throughout the drawings.

The invention is first described in connection with the embodiments comprising a flexible, collapsible tube as the container holding the lotion.

Referring to FIGS. 1-3, a first embodiment 10 of the invention is shown. Depicted is container comprising a flexible, collapsible tube for lotion or other liquids (including, but not limited to, oils, gels and pastes), which is typical of prior art containers except for the provision of a mirrored material, which in the preferred embodiment is mirrored tab 18. That is, the container includes a tube 14 which is releasably closed off at one end by the combination of circular end cap 13 and closing cap 12 and is permanently closed off at the other end by straight line seal 15. The straight line seal may be formed by any known method, including welding, heat bonding, crimping, or applying adhesives. Because of the straight line seal at one end, the tube, which has a continuous wall, appears to have a first face 16 and a second face 17.

The mirrored tab 18 is preferably, but not necessarily, formed of a flexible material and is affixed to the exterior surface of the wall of the tube by a flexible adhesive. (As used herein, the term “mirrored” when used to describe a material, means that the material has a surface capable of reflecting sufficient undiffused light to form an image of an object placed in front of it.)

The mirrored tab may be affixed to the exterior surface of the tube wall by other means as well, including but not limited to, welding or heat bonding.

The mirrored tab is preferably affixed to the first or second face of the tube near the end adjacent the straight line seal. This portion of the container is the flattest, and the mirrored tab affixed there can provide a relatively undistorted reflection. (In the embodiment depicted in FIGS. 1-3, the mirrored tab is affixed to the first face of the tube.) As indicated above, a mirrored tab formed of a rigid material would also work, although a flexible tab is preferred.

A lotion user can thus dispense lotion from its container in a customary manner and apply it to his or her face (or other body parts) with the aid of a mirrored surface which is readily available.

In another embodiment of the invention (embodiment 20 shown in FIG. 4), at least a portion of the tube wall is formed of mirrored material 19. The mirrored material is preferably, but not necessarily, flexible. In the preferred embodiment, the mirrored material is mirrored tab 18 which is attached to the rest of the first or second face of the tube wall in sealed relationship by any known method, including welding, heat bonding, crimping, or applying adhesives. The reflecting surface of the mirrored material faces outward.

FIGS. 5-7 illustrate the embodiment 30 of invention in which the container for lotion is a flexible-walled bottle 34, for lotion or other liquids (including, but not limited to, oils, gels and pastes), which bottle is releasably closed off at one end by closing cap 32 and is permanently closed off at the other end by a bottom wall 35. The bottle is typically formed with a continuous side wall, although the side wall can be formed of contiguous sections sealed together. Also typically, the side wall is configured such that it is wider than it is deep such that it appears to have a first face 36 and a second face 37. The walls are typically formed of flexible plastic.

Mirrored tab 18 is affixed to the exterior surface of a wall of the bottle, preferably at the center of the width of the first or second face of the side wall. This portion of the side wall of this container is the flattest, and the mirrored tab affixed there can provide a relatively undistorted reflection. (In the embodiment depicted in FIGS. 5-7, the mirrored tab is affixed to the first face 36 of the bottle's side wall.)

In FIG. 8, a mirrored tab 38 is shown affixed to bottom wall 35. This mirrored tab is used in place of mirrored tab 18, although both mirrored tabs could be affixed to the bottle. Since bottom wall 35 is usually flat, mirrored tab 38 need not be flexible. In the preferred version of a bottle having a mirrored material at its bottom, the bottom wall is formed with a recess into which the mirrored material fits so that the mirrored material does not usually contact a surface on which the bottle is rested.

In another embodiment of the invention (embodiment 40 shown in FIG. 9), at least a portion of a wall is formed of mirrored material 19, with the reflective surface facing outward. In the embodiment shown in FIG. 9, a portion of face 37 of the side wall near its bottom center is formed of mirrored material. In the preferred embodiment, the mirrored material is mirrored tab 18 which is attached in sealed relationship, such as by welding or gluing, to the rest of the wall.

FIGS. 10 and 11 illustrate another embodiment 50 of the invention. In this embodiment, the container shown is a flexible tube such as shown in FIGS. 1-3 with a mirrored material attached to an exterior surface of the closing cap 12. Closing cap 12 has a first exterior surface which lies along a cylinder having an axis coincident with the longitudinal axis of the tube and a second exterior surface which lies in a plane which is perpendicular to the longitudinal axis. When the mirrored material is affixed to the first exterior surface, it would normally be more convenient if the mirrored material is flexible. In the preferred version of this embodiment, a mirrored tab in the form of disc 58 is attached by an adhesive to the closing cap's second exterior surface. In this preferred version the mirrored tab may be flexible, though a rigid tab would likely work as well. The second exterior surface of the closing cap may be formed with a recess so that the outer surface of the disc 58 is flush with or slightly recessed from the rim of the closing cap.

It will be understood that various changes of the details, materials, steps, arrangement of parts and uses which have been herein described and illustrated in order to explain the nature of the invention will occur to and may be made by those skilled in the art, and such changes are intended to be included within the scope of this invention.

We claim the following:

1. A container comprising:
a flexible wall having an exterior surface; and
a mirrored material affixed to said exterior surface of said wall.

2. The container of claim 1, said container comprising a tube, said tube comprising said wall, wherein said tube is sealed at one end by a straight line seal, whereby the tube appears to comprise first and second faces, and wherein said mirrored material is affixed to said first face near said straight line seal.

3. The container of claim 2, wherein said mirrored material is a mirrored tab.

4. The container of claim 2, wherein said mirrored material is affixed to said wall with an adhesive.

5. The container of claim 4, wherein said adhesive is a flexible adhesive.

6. The container of claim 1, wherein said mirrored material is flexible.

7. The container of claim 1 wherein said flexible wall is a bottom wall to which said mirrored material is affixed, said container also comprising a flexible side wall.

8. A container comprising a flexible wall, wherein at least a portion of said wall is formed of mirrored material facing outward.

9. The container of claim 8, said container comprising a flexible tube, said tube comprising said flexible wall, said tube being sealed at one end by a straight line seal, whereby the tube appears to comprise first and second faces, and wherein at least a portion of said wall is formed of mirrored material.

10. The container of claim 9 wherein said portion of said wall formed of mirrored material is disposed near said straight line seal and is attached in sealed relationship to the rest of the wall.

11. The container of claim 8, wherein said mirrored material is flexible.

12. A container comprising a flexible wall, said flexible wall having a flexible wall exterior surface, and a closing cap, said closing cap having a closing cap exterior surface, and a mirrored material affixed to at least one of said exterior surfaces.

13. The container of claim 12, wherein said mirrored material is affixed to said closing cap exterior surface.
